(19) United States
(12) Patent Application Publication
(10) Pub. No.: US 2021/0234932 A1
(43) Pub. Date: Jul. 29, 2021

(54) DYNAMIC TIME-BASED PLAYBACK OF CONTENT IN A VEHICLE

(71) Applicant: Cobalt Industries Inc., San Francisco, CA (US)

(72) Inventor: Rana June Sobhany, Lakewood Ranch, FL (US)

(21) Appl. No.: 17/160,250

(22) Filed: Jan. 27, 2021

Related U.S. Application Data
(60) Provisional application No. 62/966,458, filed on Jan. 27, 2020.

(51) Int. Cl. H04L 29/08

(52) U.S. Cl. CPC H04L 67/18; H04L 67/14; H04L 67/12

(57) ABSTRACT

A computing device schedules media content for playback in a vehicle based on an estimated duration of an operating session of the vehicle, such that the runtime for the scheduled content approximately corresponds to the estimated operating session duration. Before an operating session, such as a drive from a first location to a specified second location or a session recharging a battery of the vehicle, the computing device determines the estimated duration of the operating session. The computing device selects one or more media content items that together have a collective runtime corresponding to the estimated duration of the operating session. During the operating session, the schedule of media is output for playback.

### CROSS-REFERENCE TO RELATED APPLICATION

This application claims the benefit of U.S. Provisional Patent Application No. 62/966,458, filed Jan. 27, 2020, which is incorporated herein by reference in its entirety.

### TECHNICAL FIELD

This disclosure relates to systems and methods for dynamically implementing playback of content in a vehicle based on a time associated with the content.

### BACKGROUND

Many people consume media content items while operating vehicles. Whether listening to music while driving or watching a movie while recharging an electric vehicle, people frequently use media content for entertainment or productivity in vehicles. However, most people select the media content to consume during an operating session of a vehicle without regard to the length of the operating session. This can cause inefficiencies in the vehicle. For example, many users will continue running the vehicle even after arriving at their destination in order to finish a song, a podcast, or a chapter of an audiobook, causing the vehicle to consume additional fuel or electric charge. Safety can also be compromised when the runtime of media content differs from the duration of an operating session. For example, a user who finishes listening to a content item before arriving at her destination may operate her mobile device to select a next content item while she is driving, distracting the user from operating the vehicle and increasing the risk of an accident caused by such a distraction.

### BRIEF DESCRIPTION OF THE DRAWINGS

FIG. 1 is a block diagram illustrating components of an example vehicle.

FIG. 2 is a block diagram illustrating an example configuration of a vehicle experience system with respect to other components of a vehicle.

FIG. 3A-3B illustrates example processing of sensor data to detect a driver's emotion.

FIG. 4 is a block diagram of an example method to output entertainment media based on time.

FIG. 5 is a block diagram of an example method to implement a selected action that corresponds to an estimated operation duration of a vehicle.

FIG. 6 is a block diagram illustrating an example of a processing system.

### DETAILED DESCRIPTION

The present embodiments relate to dynamic playback of media content in a vehicle based on time. Particularly, media content playback can be scheduled based on an estimated duration of an operating session in a vehicle, such that the schedule of media content ends at approximately the same time as the operating session. For example, upon determining that a trip in a vehicle will take 1 hour, the system may select audio content with a 1-hour run-time to play during this trip. Scheduling content items that correspond to the duration of the operating session can improve the user's experience with the vehicle.

Embodiments described herein relate to operating sessions of a vehicle. As used herein, a “vehicle” can include any type of vehicle capable of carrying one or more passengers, including any type of land-based automotive vehicle (such as cars, trucks, or buses), train, flying vehicle (such as airplanes, helicopters, or space shuttles), or aquatic vehicle (such as cruise ships). Furthermore, the vehicle can be operated by any driving mode, including fully manual (human-operated) vehicles, self-driving vehicles, or hybrid-mode vehicles that can switch between manual and self-driving modes.

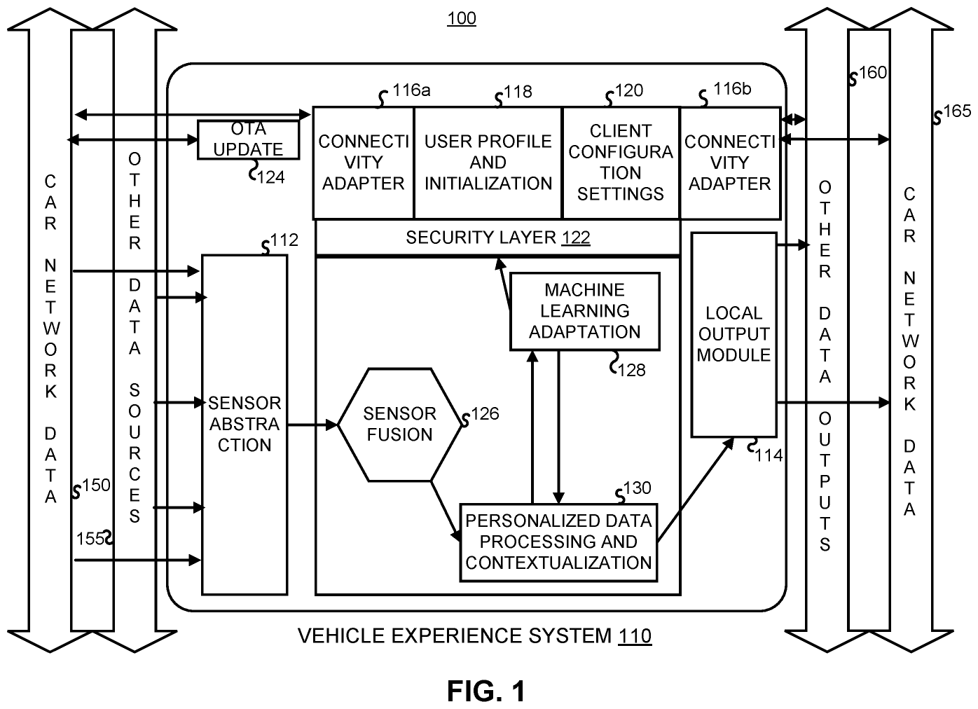

FIG. 1 is a block diagram illustrating components of a vehicle 100 in which at least some embodiments of time-based playback of media content can be performed.

As shown in FIG. 1, the vehicle 100 can include a vehicle experience system 110. The vehicle experience system 110 controls an experience for passengers in the vehicle 110. The vehicle experience system 110 can include computer software and hardware to execute the software, special-purpose hardware, or other components to implement the functionality of the media system 120 described herein. For example, the vehicle experience system 110 can include programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc. In some embodiments, the vehicle experience system is implemented using hardware in the vehicle 110 that also performs other functions of the vehicle. For example, the vehicle experience system can be implemented within an infotainment system in the vehicle 110. In other embodiments, components such as one or more processors or storage devices can be added to the vehicle 110, where some or all functionality of the vehicle experience system is implemented on the added hardware.

The vehicle experience system 110 can read and write to a car network 150. The car network 150, implemented for example as a controller area network (CAN) bus inside the vehicle 110, enables communication between components of the vehicle, including electrical systems associated with driving the vehicle (such as engine control, anti-lock brake systems, parking assist systems, and cruise control) as well as electrical system associated with comfort or experience in the interior of the vehicle (such as temperature regulation, audio systems, chair position control, or window control). The vehicle experience system 110 can also read data from or write data to other data sources 155 or other data outputs 160, including one or more other on-board buses (such as a local interconnect network (LIN) bus or comfort-CAN bus), a removable or fixed storage device (such as a USB memory stick), or a remote storage device that communicates with the vehicle experience system over a wired or wireless network.

The CAN bus 150 or other data sources 155 provide raw data from sensors inside or outside the vehicle, such as the sensors 215. Example types of data that can be made available to the vehicle experience system 110 over the CAN bus 150 include vehicle speed, acceleration, lane position, steering angle, in-cabin decibel level, audio volume level, current information displayed by a multimedia interface in the vehicle, force applied by the user to the multimedia interface, ambient light, or humidity level. Data types that may be available from other data sources 155 include raw video feed (whether from sources internal or external to the vehicle), audio input, user metadata, user state, calendar data, user observational data, contextual external data, traffic conditions, weather conditions, in-cabin occupancy information, road conditions, user drive style, or non-contact biofeedback. Any of a variety of other types of data may be available to the vehicle experience system 110.

Some embodiments of the vehicle experience system 110 process and generate all data for controlling systems and parameters of the vehicle 110, such that no processing is done remotely (e.g., by the remote server 120). Other embodiments of the vehicle experience system 110 are configured as a layer interfacing between hardware components of the vehicle 110 and the remote server 120, transmitting raw data from the car network 150 to the remote server 120 for processing and controlling systems of the vehicle 110 based on the processing by the remote server 120. Still other embodiments of the vehicle experience system 110 can perform some processing and analysis of data while sending other data to the remote server 120 for processing. For example, the vehicle experience system 110 can process raw data received over the CAN bus 150 to generate intermediate data, which may be anonymized to protect privacy of the vehicle's passengers. The intermediate data can be transmitted to and processed by the remote server 120 to generate a parameter for controlling the vehicle 110. The vehicle experience system 110 can in turn control the vehicle based on the parameter generated by the remote server 120. As another example, the vehicle experience system 110 can process some types of raw or intermediate data, while sending other types of raw or intermediate data to the server 120 for analysis.

Some embodiments of the vehicle experience system 110 can include an application programing interface (API) enabling remote computing devices, such as the remote server 120, to send data to or receive data from the vehicle 110. The API can include software configured to interface between a remote computing device and various components of the vehicle 110. For example, the API of the vehicle experience system 110 can receive an instruction to apply a parameter to the vehicle from a remote device, such as a parameter associated with entertainment content, and apply the parameter to the vehicle.

As shown in FIG. 1, some embodiments of the vehicle experience system 110 can include a sensor abstraction component 112, an output module 114, a connectivity adapter 116a-b, a user profile module 118, a settings module 120, a security layer 122, an over the air (OTA) update module 124, a processing engine 130, a sensor fusion module 126, and a machine learning adaptation module 128. Other embodiments of the vehicle experience system 110 can include additional, fewer, or different components, or can distribute functionality differently between the components. The components of the vehicle experience system 110 can include any combination of software and hardware, including, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc. In some cases, the vehicle experience system 110 includes one or more processors, such as a central processing unit (CPU), graphical processing unit (GPU), or neural processing unit (NPU), that executes instructions stored in a non-transitory computer readable storage medium, such as a memory.

The sensor abstraction component 112 receives raw sensor data from the car network 150 and/or other data sources 155 and normalizes the inputs for processing by the processing engine 130. The sensor abstraction component 112 may be adaptable to multiple vehicle models and can be readily updated as new sensors are made available.

The output module 114 generates output signals and sends the signals to the car network 165 or other data sources 160 to control electrical components of the vehicle. The output module 114 can receive a state of the vehicle and determine an output to control at least one component of the vehicle to change the state. In some embodiments, the output module 114 includes a rules engine that applies one or more rules to the vehicle state and determines, based on the rules, one or more outputs to change the vehicle state. For example, if the vehicle state is drowsiness of the driver, the rules may cause the output module to generate output signals to reduce the temperature in the vehicle, change the radio to a predefined energetic station, and increase the volume of the radio.

The connectivity adapter 116a-b enables communication between the vehicle experience system 110 and external storage devices or processing systems. The connectivity adapter 116a-b can enable the vehicle experience system 110 to be updated remotely to provide improved capability and to help improve the vehicle state detection models applied by the processing engine. The connectivity adapter 116a-b can also enable the vehicle experience system 110 to output vehicle or user data to a remote storage device or processing system. For example, the vehicle or user data can be output to allow a system to analyze for insights or monetization opportunities from the vehicle population. In some embodiments, the connectivity adapter can interface between the vehicle experience system 110 and wireless network capabilities in the vehicle. Data transmission to or from the connectivity adapter can be restricted by rules, such as limits on specific hours of the day when data can be transmitted or maximum data transfer size. The connectivity adapter may also include multi-modal support for different wireless methods (e.g., 5G or WiFi).

The user profile module 118 manages profile data of a user of the vehicle (such as a driver). Because the automotive experience generated by the vehicle experience system 110 can be highly personalized for each individual user in some implementations, the user profile module generates and maintains a unique profile for the user. The user profile module can encrypt the profile data for storage. The data stored by the user profile module may not be accessible over the air. In some embodiments, the user profile module maintains a profile for any regular driver of a car, and may additionally maintain a profile for a passenger of the car (such as a front seat passenger). In other embodiments, the user profile module 118 accesses a user profile, for example from the remote server 120, when a user enters the vehicle 110.

The settings module 120 improves the flexibility of system customizations that enable the vehicle experience system 110 to be implemented on a variety of vehicle platforms. The settings module can store configuration settings that streamline client integration, reducing an amount of time to implement the system in a new vehicle. The configuration settings also can be used to update the vehicle during its lifecycle, to help improve with new technology, or keep current with any government regulations or standards that change after vehicle production. The configuration settings stored by the settings module can be allowed locally through a dealership update or remotely using a remote campaign management program to update vehicles over the air.

The security layer 122 manages data security for the vehicle experience system 110. In some embodiments, the security layer encrypts data for storage locally on the vehicle and when sent over the air to deter malicious attempts to extract private information. Individual anonymization and obscuration can be implemented to separate personal details as needed. The security and privacy policies employed by the security layer can be configurable to update the vehicle experience system 110 for compliance with changing government or industry regulations.

In some embodiments, the security layer 122 implements a privacy policy. The privacy policy can include rules specifying types of data that can or cannot be transmitted to the remote server 120 for processing. For example, the privacy policy may include a rule specifying that all data is to be processed locally, or a rule specifying that some types of intermediate data scrubbed of personally identifiable information can be transmitted to the remote server 120. The privacy policy can, in some implementations, be configured by an owner of the vehicle 110. For example, the owner can select a high privacy level (where all data is processed locally), a low privacy level with enhanced functionality (where data is processed at the remote server 120), or one or more intermediate privacy levels (where some data is processed locally and some is processed remotely).

Alternatively, the privacy policy can be associated with one or more privacy profiles defined for the vehicle 110, a passenger in the vehicle, or a combination of passengers in the vehicle, where each privacy profile can include different rules. In some implementations, where for example a passenger is associated with a profile that is ported to different vehicles or environment, the passenger's profile can specify the privacy rules that are applied dynamically by the security layer 122 when the passenger is in the vehicle 110 or environment. When the passenger exits the vehicle and a new passenger enters, the security layer 122 retrieves and applies the privacy policy of the new passenger.

The rules in the privacy policy can specify different privacy levels that apply under different conditions. For example, a privacy policy can include a low privacy level that applies when a passenger is alone in a vehicle and a high privacy level that applies when the passenger is not alone in the vehicle. Similarly, a privacy policy can include a high privacy level that applies if the passenger is in the vehicle with a designated other person (such as a child, boss, or client) and a low privacy level that applies if the passenger is in the vehicle with any person other than the designated person. The rules in the privacy policy, including the privacy levels and when they apply, may be configurable by the associated passenger. In some cases, the vehicle experience system 110 can automatically generate the rules based on analysis of the passenger's habits, such as by using pattern tracking to identify that the passenger changes the privacy level when in a vehicle with a designated other person.

The OTA update module 124 enables remote updates to the vehicle experience system 110. In some embodiments, the vehicle experience system 110 can be updated in at least two ways. One method is a configuration file update that adjusts system parameters and rules. The second method is to replace some or all of firmware associated with the system to update the software as a modular component to host vehicle device.

The processing engine 130 processes sensor data and determines a state of the vehicle. The vehicle state can include any information about the vehicle itself, the driver, or a passenger in the vehicle. For example, the state can include an emotion of the driver, an emotion of the passenger, or a safety concern (e.g., due to road or traffic conditions, the driver's attentiveness or emotion, or other factors). As shown in FIG. 1, the processing engine can include a sensor fusion module, a personalized data processing module, and a machine learning adaptation module.

The sensor fusion module 126 receives normalized sensor inputs from the sensor abstraction component 112 and performs pre-processing on the normalized data. This pre-processing can include, for example, performing data alignment or filtering the sensor data. Depending on the type of data, the pre-processing can include more sophisticated processing and analysis of the data. For example, the sensor fusion module 126 may generate a spectrum analysis of voice data received via a microphone in the vehicle (e.g., by performing a Fourier transform), determining frequency components in the voice data and coefficients that indicate respective magnitudes of the detected frequencies. As another example, the sensor fusion module may perform image recognition processes on camera data to, for example, determine the position of the driver's head with respect to the vehicle or to analyze an expression on the driver's face.

The personalized data processing module 130 applies a model to the sensor data to determine the state of the vehicle. The model can include any of a variety of classifiers, neural networks, or other machine learning or statistical models enabling the personalized data processing module to determine the vehicle's state based on the sensor data. Once the vehicle state has been determined, the personalized data processing module can apply one or more models to select vehicle outputs to change the state of the vehicle. For example, the models can map the vehicle state to one or more outputs that, when effected, will cause the vehicle state to change in a desired manner.

The machine learning adaptation module 128 continuously learns about the user of the vehicle as more data is ingested over time. The machine learning adaptation module may receive feedback indicating the user's response to the vehicle experience system 110 outputs and use the feedback to continuously improve the models applied by the personalized data processing module. For example, the machine learning adaptation module 128 may continuously receive determinations of the vehicle state. The machine learning adaptation module can use changes in the determined vehicle state, along with indications of the vehicle experience system 110 outputs, as training data to continuously train the models applied by the personalized data processing module.

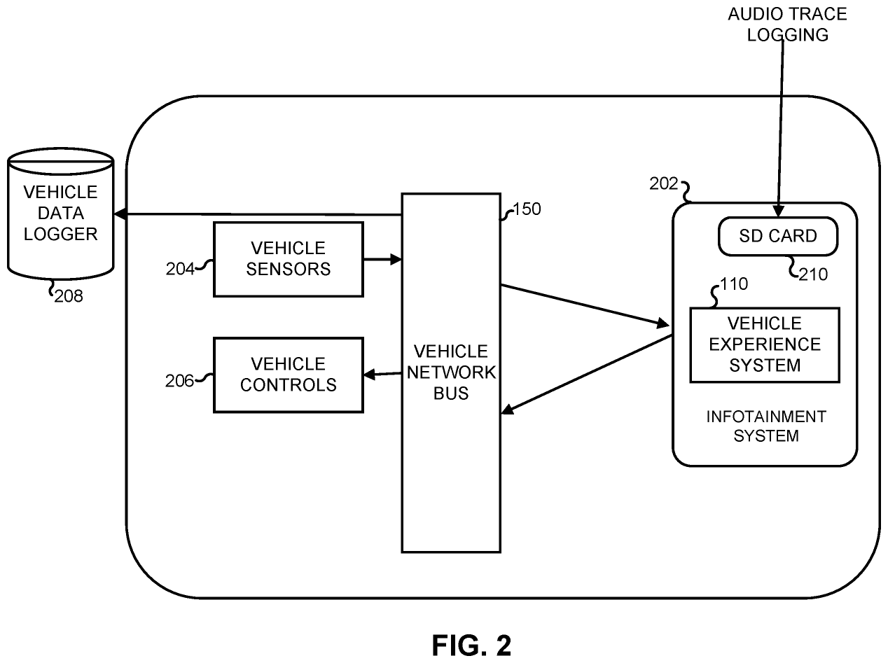

FIG. 2 is a block diagram illustrating an example configuration of the vehicle experience system with respect to other components of the vehicle. As shown in FIG. 2, the vehicle 110 can include an infotainment system 202, vehicle sensors 204, vehicle controls 206, and a vehicle data logger 208, which can communicate over a vehicle network 150.

The infotainment system 202 is a system within the vehicle 110 to output information to users and receive inputs from users while the users ride in the vehicle. The infotainment system 202 can include one or more output devices (such as displays, speakers, or scent output devices), as well as one or more input devices (such as physical buttons or knobs, one or more touchscreens, one or more microphones to receive audio inputs, or cameras to capture gesture inputs). Also included in at least some embodiments of the infotainment system 202 are processors or other computing devices capable of processing inputs or outputs, and a communications interface to communicate with external systems. In some embodiments, the infotainment system 202 can also include a storage device 210, such as an SD card, to store data related to the infotainment system, such as audio logs, phone contacts, or favorite addresses for a navigation system.

The infotainment system 202 can include the vehicle experience system 110. The vehicle experience system 110, comprising software executed by a processor that is dedicated to the vehicle experience system 110 or that is configured to perform functions associated with the broader infotainment system 202, interfaces between components of the vehicle and external devices such as the vehicle management platform 120 or the user device 130 to enable the external devices to implement configurations in the internal environment of the vehicle.

The infotainment system 202, along with vehicle sensors 204 and vehicle controls 206, can communicate with other electrical components of the vehicle over the car network 150. The vehicle sensors 204 can include any of a variety of sensors capable of measuring internal or external features of the vehicle, such as a global positioning sensor, internal or external cameras, eye tracking sensors, temperature sensors, audio sensors, weight sensors in a seat, force sensors measuring force applied to devices such as a steering wheel or display, accelerometers, gyroscopes, light detecting and ranging (LIDAR) sensors, or infrared sensors. The vehicle controls 206 can control various components of the vehicle. A vehicle data logger 208 may store data read from the car network bus 150, for example for operation of the vehicle. In some embodiments, the infotainment system 202 can also include a storage device 210, such as an SD card, to store data related to the infotainment system, such as audio logs, phone contacts, or favorite addresses for a navigation system. The infotainment system 202 can include an automotive system 110 that can be utilized to increase user experience in the vehicle.

Although FIG. 2 shows that the vehicle experience system 110 may be integrated into the vehicle infotainment system in some cases, other embodiments of the vehicle experience system 110 may be implemented using standalone hardware. For example, one or more processors, storage devices, or other computer hardware can be added to the vehicle and communicatively coupled to the vehicle network bus, where some or all functionality of the vehicle experience system 110 can be implemented on the added hardware.

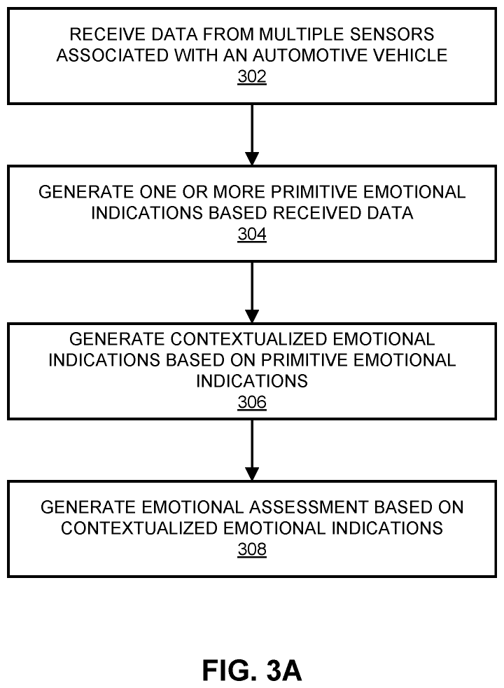

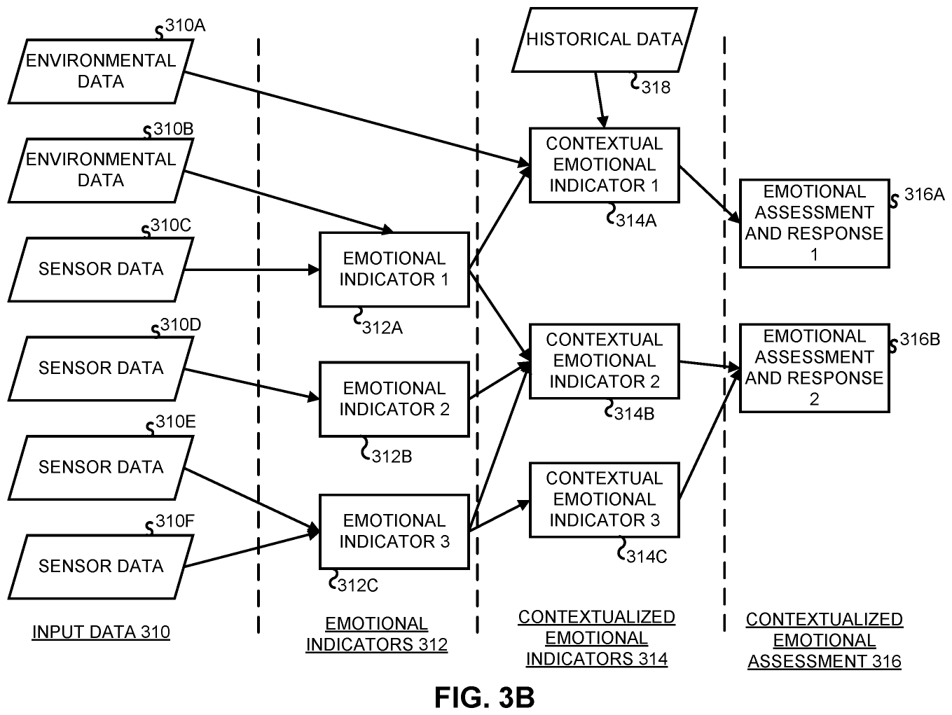

FIG. 3A is a flowchart illustrating a process to determine the driver's emotional state, and FIG. 3B illustrates example data types detected and generated during the process shown in FIG. 3A. The processing in FIG. 3A is described, by way of example, as being performed by the vehicle experience system 110. However, in other embodiments, other components of the vehicle 110 or a remote device, such as a user device or a cloud server, can perform some or all of the analysis shown in FIG. 3A.

As shown in FIG. 3A, the vehicle experience system 110 can receive, at step 302, data from multiple sensors associated with an automotive vehicle. In addition to the sensor data, the vehicle experience system 110 may receive environmental data indicating, for example, weather or traffic conditions measured by systems other than the vehicle experience system 110 or the sensors associated with the vehicle. FIG. 3B shows, by way of example, four types of sensor data and two types of environmental data that can be received at step 302. However, additional or fewer data streams can be received by the vehicle experience system 110.

As shown in FIG. 3B, the types of environmental data can include input data 310, emotional indicators 312, contextualized emotional indicators 314, and contextual emotional assessment 316. The input data 310 can include environmental data 310a-b and sensor data 310c-f. The emotional indicators 312 can include indicators 312a-c. The contextual emotional indicators 314 can include indicators 314a-c. In some cases, the contextual emotional indicators 314a-c can be modified based on historical data 318. The contextualized emotional assessments 316 can include various emotional assessments and responses 316a-b.

The vehicle experience system 110 generates, at step 304, one or more primitive emotional indications based on the received sensor (and optionally environmental) data. The primitive emotional indications may be generated by applying a set of rules to the received data. When applied, each rule can cause the vehicle experience system 110 to determine that a primitive emotional indication exists if a criterion associated with the rule is satisfied by the sensor data. Each rule may be satisfied by data from a single sensor or by data from multiple sensors.

As an example of generating a primitive emotional indication based on data from a single sensor, a primitive emotional indication determined at step 304 may be a classification of a timbre of the driver's voice into soprano, mezzo, alto, tenor, or bass. To determine the timbre, the vehicle experience system 110 can analyze the frequency content of voice data received from a microphone in the vehicle. For example, the vehicle experience system 110 can generate a spectrum analysis identify various frequency components in the voice data. A rule can classify the voice as soprano if the frequency data satisfies a first condition or set of conditions, such as having certain specified frequencies represented in the voice data or having at least threshold magnitudes at specified frequencies. The rule can classify the voice as mezzo, alto, tenor, or bass if the voice data instead satisfies a set of conditions respectively associated with each category.

As an example of generating a primitive emotional indication based on data from multiple sensors, a primitive emotional indication determined at step 304 may be a body position of the driver. The body position can be determined based on data received from a camera and one or more weight sensors in the driver's seat. For example, the driver can be determined to be sitting up straight if the camera data indicates that the driver's head is at a certain vertical position and the weight sensor data indicates that the driver's weight is approximately centered and evenly distributed on the seat. The driver can instead be determined to be slouching based on the same weight sensor data, but with camera data indicating that the driver's head is at a lower vertical position.

The vehicle experience system 110 may determine the primitive emotional indications in manners other than by the application of the set of rules. For example, the vehicle experience system 110 may apply the sensor and/or environmental data to one or more trained models, such as a classifier that outputs the indications based on the data from one or more sensors or external data sources. Each model may take all sensor data and environmental data as inputs to determine the primitive emotional indications or may take a subset of the data streams. For example, the vehicle experience system 110 may apply a different model for determining each of several types of primitive emotional indications, where each model may receive data from one or more sensors or external sources.

Example primitive emotional indicators that may be generated by the media selection module 220, as well as the sensor data used by the module to generate the indicators, are as follows:

| Primitive | | |
|---|---|---|
| Emotional | | |
| Indicator | Description | Sensor Needed |
| Voice | | |
| Timbre | Unique Overtones and | Microphone |
| | frequency of the voice. | |
| | Categorized as: | |
| | Soprano | |
| | Mezzo | |
| | Alto | |
| | Tenor | |
| | Bass | |
| Decibel Level | Absolute decibel level of the | Microphone |
| | human voice detected. | |
| Pace | The cadence at which the subject | Microphone |
| | is speaking | |
| Facial | | |
| Anger | The detection that the occupant is | Front Facing |
| | angry and unhappy with something | Camera |
| Disgust | The response from a subject of | Front Facing |
| | distaste or displeasure | Camera |
| Happiness | Happy and general reaction of | Front Facing |
| | pleasure | Camera |
| Sadness | Unhappy or sad response | Front Facing |
| | | Camera |
| Surprise | Unexpected situation | Front Facing |
| | | Camera |
| Neutral | No specific emotional | Front Facing |
| | response. | Camera |
| Body | | |
| Force of Touch | The level of pressure applied to the | Entertainment/ |
| | Entertainment screen with a user | Infotainment screen |
| | interaction | |
| Body Position | The position of the subject body, | Camera + Occupant |
| | detected by computer vision in | Weight Sensor |
| | combination with the seat sensors | |
| | and captured in X, Y, Z coordinates | |

Based on the primitive emotional indications (and optionally also based on the sensor data, the environmental data, or historical data associated with the user), the vehicle experience system 110 generates, at step 306, contextualized emotional indications. Each contextualized emotional indication can be generated based on multiple types of data, such as one or more primitive emotional indications, one or more types of raw sensor or environmental data, or one or more pieces of historical data. By basing the contextualized emotional indications on multiple types of data, the vehicle experience system 110 can more accurately identify the driver's emotional state and, in some cases, the reason for the emotional state.

In some embodiments, the contextualized emotional indications can be determined by applying a set of rules to the primitive indications. For example, the vehicle experience system 110 may determine that contextual emotional indication 2 shown in FIG. 3B exists if the system detected primitive emotional indications 1, 2, and 1. Below is an example emotional indication model including rules that can be applied by the vehicle experience system 110:
Happy:
Event Detected: Mouth changes shape, corners turn upwards, timbre of voice moves up half an octave
Classification: Smile
Contextualization: Weather is good, traffic eases up
Verification: Positive valence
Output/Action: Driver is happy, system proposes choices to driver based on ambience, music, driving style, climate control, follow-up activities, linked activities, driving route, suggestions, alternative appointment planning, continuous self-learning, seat position, creating individualized routines for relaxation or destressing.

In other cases, the contextualized emotional indications can be determined by applying a trained model, such as a neural network or classifier, to multiple types of data. For example, primitive emotional indication 1 shown in FIG. 3A may be a determination that the driver is happy. The vehicle experience system 110 can generate contextualized emotional indication 1—a determination that the driver is happy because the weather is good and traffic is light—by applying primitive emotional indication 1 and environmental data (such as weather and traffic data) to a classifier. The classifier can be trained based on historical data, indicating for example that the driver tends to be happy when the weather is good and traffic is light, versus being angry, frustrated, or sad when it is raining or traffic is heavy. In some cases, the model is trained using explicit feedback provided by the passenger. For example, if the vehicle experience system 110 determines based on sensor data that a person is stressed, the vehicle experience system 110 may ask the person “You appear to be stressed; is that true?” The person's answer to the question can be used as an affirmative label to retrain and improve the model for better determination of the contextualized emotional indications.

The contextualized emotional indications can include a determination of a reason causing the driver to exhibit the primitive emotional indications. For example, different contextualized emotional indications can be generated at a different times based on the same primitive emotional indication with different environmental and/or historical data. For example, as discussed above, the vehicle experience system 110 may identify a primitive emotional indication of happiness and a first contextualized emotional indication indicating that the driver is happy because the weather is good and traffic is light. At a different time, the vehicle experience system 110 may identify a second contextualized emotional indication based on the same primitive emotional indication (happiness), which indicates that the driver is happy in spite of bad weather or heavy traffic as a result of the music that is playing in the vehicle. In this case, the second contextualized emotional indication may be a determination that the driver is happy because she enjoys the music.

Finally, at step 308, the vehicle experience system 110 can use the contextualized emotional indications to generate or recommend one or more emotional assessment and response plans. The emotional assessment and response plans may be designed to enhance the driver's current emotional state (as indicated by one or more contextualized emotional indications), mitigate the emotional state, or change the emotional state. For example, if the contextualized emotional indication indicates that the driver is happy because she enjoys the music that is playing in the vehicle, the vehicle experience system 110 can select additional songs similar to the song that the driver enjoyed to ensure that the driver remains happy. As another example, if the driver is currently frustrated due to heavy traffic but the vehicle experience system 110 has determined (based on historical data) that the driver will become happier if certain music is played, the vehicle experience system 110 can play this music to change the driver's emotional state from frustration to happiness. Below are example scenarios and corresponding corrective responses that can be generated by the vehicle experience system 110:

| Context- | | Primitive | |
|---|---|---|---|
| ualized | | Emotional | Personalized |
| Emotional | | Indicators and | Corrective |
| Scenario | Description | Sensors | Response |
| Safety | | | |
| Road Rage | The personalized | Vehicle | Audio and |
| | assessment that a | Power Train - | visual warning |
| | driver is aggravated | Speed, | for driver to be |
| | to the point that | Acceleration | aware of |
| | their actions could | External - | situation. |
| | harm themselves or | Traffic, | Massage |
| | others. This | weather | activated on |
| | assessment will take | Emotional | seat. |
| | into consideration | Indicators of | Temperature |
| | the history of the | Anger and | reduced in |
| | specific user and | Disgust | vehicle |
| | have a | Body Position | Mood lighting |
| | personalized | Deltas - | adjusted to be |
| | threshold it will | Physical | less upsetting |
| | learn overtime | Agitation | (no red) |
| Entertainment | | | |
| Head Bop | The physical | Front Facing | None - Captured |
| | reaction a subject | Camera (Facial | Data Point to be |
| | has while listening | changes, | used for analysis |
| | to a media source. | mouthing words) | or joined with |
| | This goes beyond | Body | other data |
| | simple enjoyment, | Position | for behavioral |
| | to the mode of | (Delta) | analysis and/or |
| | physical reaction | Cabin | monetization |
| | the user | Microphone | purposes |
| | demonstrates. | (musicbpm, key | |
| | This can be | signature) | |
| | parameterized as | Entertainment | |
| | Metal, Sway, Pop. | Media Metadata | |
| | | (song, artist, | |
| | | timestamp, | |
| | | volume change) | |
| Comfort | | | |
| Emotional | This feature will | Front Facing | Change of |
| Stability | assess the desired | Camera | Audio Station |
| | emotional state of | Body | Massage |
| | the occupant, and | Position | activated on |
| | adjust the | (Delta) | seat. |
| | environment to | Cabin | Cabin |
| | maintain that state | Microphone | temperature |
| | for the subject. The | Infotainment | adjusted in |
| | requested state will | Status | vehicle |
| | be requested by the | | Mood lighting |
| | user, and can be | | adjustments |
| | Calm, Sad, Intense | | Seat temperature |
| | or Happy. | | |

The following table illustrates other example state changes that can be achieved by the vehicle experience system 110, including the data inputs used to determine a current state, an interpretation of the data, and outputs that can be generated to change the state.

| Emotional | | System | |
|---|---|---|---|
| Scenario | Data Input | Interpretation | Output |
| Stress | Driver Monitoring | Facial Coding | Alternative Route |
| Reduction | Camera | analysis | Suggestions |
| | Analog Microphone | Voice frequency | Interactive spoken prompts |
| | Signal | detection | to driver |
| | DSP: Music beat | Breathing | Enhanced proactive |
| | detection | patterns | communication regarding |
| | DSP: Processed audio | Deviation from | uncontrollable stress factors: |
| | CAN Data: Speed | historical user | weather, traffic conditions, |
| | CAN Data: Acceleration | behavior | location of fueling and rest |
| | CAN Data: In-cabin | Intensity of | areas, etc. |
| | decibel level | acceleration | Activation of adaptive cruise |
| | External data: Traffic | Anomaly | control (ACC) |
| | conditions | detection from norm | Activation of Lane Assist |
| | External data: Weather | Pupils dilated | Modify the light experience |
| | condition | Posture | Air purification activated |
| | | recognition | Regulate the sound level |
| | | Gesture detection | Aromatherapy activation |
| | | Restlessness | Dynamic audio volume |
| | | detection | modification |
| | | | Dynamic drive mode |
| | | | adjustment |
| | | | Activate seat massage |
| | | | Adjust seat position |
| Music | Driver Monitoring | Posture | Lighting becomes |
| Enjoyment | Camera | recognition | dynamically reactive to music |
| | Analog Microphone | Gesture detection | All driver assist functions |
| | Signal | Voice frequency | activated (e.g. ACC, Lane |
| | DSP: Music beat | detection | Assist) |
| | detection | Facial expression | Dynamically-generated |
| | DSP: In-Cabin Decibel | change | music recommendations |
| | Level | Zonal | designed for the specific length |
| | CAN Data: Humidity | determination of | of the journey |
| | Detection | music enjoyment | Deactivate seat massage |
| | CAN Data: Acceleration | Facial Expression | Lower temperature based |
| | CAN Data: Increase in | determination | on increased movement and |
| | volume level | Voice frequency | humidity |
| | CAN Data: Audio screen | detection | Dynamic drive mode |
| | in MMI | Upper body pose | adjustment to comfort mode |
| | External data: Traffic | estimation | When car stopped, Karaoke |
| | conditions | Correlation to | Mode activated |
| | External data: Weather | past user behavior | |
| | conditions | Detect audio key | |
| | | signature | |
| | | Intensity of | |
| | | acceleration | |
| Road Rage | External data: Traffic | Upper body pose | Alternative Route |
| Abatement | conditions | Facial Expression | Suggestions |
| | Driver Monitoring | determination | Interactive spoken prompts |
| | Camera | Voice frequency | to driver |
| | Analog Microphone | detection | Explain through simple |
| | Signal | Breathing | language the contributing |
| | DSP: Processed Audio | patterns | stress factors: Enhanced |
| | Signal | Deviation from | proactive communication |
| | CAN Data: Audio | historical user | regarding uncontrollable stress |
| | volume level | behavior | factors: weather, traffic |
| | CAN Data: Distance to | Intensity of | conditions, location of fueling |
| | car ahead | acceleration | and rest areas, etc. |
| | CAN Data: Lane | Check for erratic | Activation of ACC |
| | position | driving | Activation of Lane Assist |
| | CAN Data: Speed | Anomaly | Modify the light experience |
| | CAN Data: Acceleration | detection from norm | Regulate the sound level |
| | CAN Data: In-cabin | Pupils dilated | Air purification activated |
| | decibel level | Posture | Aromatherapy activation |
| | External data: Weather | recognition | Dynamic audio volume |
| | conditions | Gesture detection | modification |
| | DSP: External noise | Restlessness | Dynamic drive mode |
| | pollution | detection | adjustment |
| | CAN Data: Force touch | Steering style | Activate seat massage |
| | detection | Restlessness | Adjust seat position |
| | CAN Data: Steering | | Adjust to average user |
| | wheel angle | | comfort setting |
| | Body seating position | | |
| | CAN Data: Passenger | | |
| | seating location | | |
| Tech Detox | Driver Monitoring | Facial stress | Countermeasures |
| | Camera | detection | Scent |
| | Analog Microphone | Voice frequency | Music |
| | Signal | changes | Alternative Route |
| | Cobalt DSP: In-Cabin | Breathing | Suggestions |
| | Decibel Level | patterns | Spoken |
| | CAN Data: Ambient | Slow response to | Acceleration- Air purification |
| | Light Sensor | factors | activated |
| | CAN Data: Infotainment | Pupils dilated | Activation of security system |
| | Force Touch | Posture | Proactive communication |
| | CAN Data: Decrease in | recognition | regarding weather, traffic |
| | volume level | Gesture detection | conditions, rest areas, etc. |
| | CAN Data: Audio screen | Color | Dynamic drive mode |
| | in infotainment system | temperature of in- | adjustment |
| | External data: Traffic | vehicle lights | |
| | conditions | Correlation with | |
| | External data: Weather | weather | |
| | condition | | |
| Do Not | CAN Data: Passenger | Rate of change | Countermeasures |
| Disturb | seating | against expected | Scent |
| | location | norm | Music |
| | Body seating position | Frequency | Alternative Route |
| | Driver Monitoring | Intensity | Suggestion |
| | Camera | Delta of detected | Spoken |
| | Analog Microphone | events from typical | Acceleration |
| | Signal | status | Activation of security system |
| | DSP: Processed Audio | | Proactive communication |
| | Signal | | regarding weather, traffic |
| | CAN Data: Audio | | conditions, rest areas, etc. |
| | volume level | | Dynamic drive mode |
| | CAN Data: Drive mode: | | adjustment |
| | comfort | | |
| | CAN Data: In-cabin | | |
| | decibel level | | |
| | CAN Data: Day and | | |
| | Time | | |
| | External data: Weather | | |
| | conditions | | |
| | DSP: External noise | | |
| | pollution | | |
| Drowsiness | Driver Monitoring | Zonal detection | Countermeasures |
| | Camera | Blink detection | Scent |
| | Body seating position | Drive Style | Music |
| | Analog Microphone | Steering Style | Alternative Route |
| | Signal | Rate of change | Suggestions |
| | DSP: Processed Audio | against expected | Spoken |
| | Signal | norm | Acceleration - Air purification |
| | CAN Data: Steering | Frequency | activated |
| | Angle | Intensity | Activation of security |
| | CAN Data: Lane | Delta of detected | systems |
| | departure | event from typical | Proactive communication |
| | CAN Data: Duration of | status | regarding weather, traffic |
| | journey | | conditions, rest areas, etc. |
| | CAN Data: Day and | | ″Shall I open the windows″ |
| | Time | | Dynamic drive mode |
| | CAN Data: Road Profile | | adjustment |
| | Estimation | | Significant cooling of interior |
| | External data: Weather | | cabin temperature |
| | conditions | | Adapting driving mode to |
| | CAN Data: Audio level | | auto mode (detect the bumpy |
| | | | road) |
| Driver | Driver Monitoring | Rate of change | Countermeasures |
| Distraction | Camera | against expected | Scent |
| | Analog Microphone | norm | Music |
| | Signal | Frequency | Alternative Route |
| | DSP: Vocal frequency | Intensity | Suggestions |
| | DSP: Processed audio | Delta of detected | Spoken |
| | CAN Data: Lane | events from typical | Acceleration |
| | departure | status | Activation of security |
| | CAN Data: MMI Force | | systems |
| | Touch | | Proactive communication |
| | CAN Data: In-cabin | | regarding weather, traffic |
| | decibel level | | conditions, rest areas, etc. |
| | CAN Data: Mobile | | Dynamic drive mode |
| | phone notification and call | | adjustment |
| | information | | |
| | External data: Traffic | | |
| | conditions | | |
| | External data: Weather | | |
| | condition | | |

Current implementations of emotion technology suffer by their reliance on a classical model of Darwinian emotion measurement and classification. One example of this is the wide number of facial coding-only offerings, as facial coding on its own is not necessarily an accurate representation of emotional state. In the facial coding-only model, emotional classification is contingent upon a correlational relationship between the expression and the emotion it represents (for example: a smile always means happy). However, emotions are typically more complex. For example, a driver who is frustrated as a result of heavy traffic may smile or laugh when another vehicle cuts in front of him as an expression of his anger, rather than an expression of happiness. Embodiments of the vehicle experience system 110 take a causation-based approach to biofeedback by contextualizing each data point that paints a more robust view of emotion. These contextualized emotions enable the vehicle experience system 110 to more accurately identify the driver's actual, potentially complex emotional state, and in turn to better control outputs of the vehicle to mitigate or enhance that state.

### Time-Based Selection of Entertainment Content

Individuals within a vehicle environment (an automobile, truck, train, airplane, etc.) generally have access to various types and items of media content. For instance, a passenger of a vehicle can have access to various video and audio content. This media content can be stored locally at a vehicle or streamed via an external device (e.g., a mobile device associated with the user, a remote server) via a suitable communication interface (Bluetooth®, Wi-Fi, etc.). The media content that is output to a user in the vehicle generally includes a duration. For instance, a movie can have a run-time of 2 hours, while a song has a run-time of 4 minutes.

Further, individuals may be in the vehicle for a specific amount of time. For example, a passenger may remain in a vehicle for 45 minutes during a commute from their home to a place of business. In many instances, mapping applications are utilized to identify a desired route to a destination along with traffic information and an estimated time of arrival. However, the estimated time duration in a vehicle is generally different than a run-time of media content. For example, if the time in the vehicle is 45 minutes and a run-time of a podcast is 1 hour, the podcast may still have remaining time to play when the vehicle has reached its duration. Alternatively, if the run-time of audio content is less than a operation time of the vehicle, the audio content may end prior to the vehicle reaching its destination. This may generally reduce user experience in the vehicle.

Accordingly, the present embodiments relate to dynamic playback of media content in a vehicle based on time. Particularly, media content playback can be scheduled based on an estimated duration of an operating session in a vehicle. For example, upon determining that a trip in a vehicle is expected to take 1 hour, the system selects audio content with an approximately one-hour run-time to play during this trip.

While media content is described herein primarily with respect to entertainment content, the present embodiments can relate to any type of content. For example, the present embodiments can schedule times for phone conversations with others during an operating session in a vehicle. This can be based on determining average call times with various individuals and scheduling call(s) with individuals with average call times that correspond to the estimated operation duration in the vehicle. In another example, crowdsourced work tasks can be selected based on an estimated duration to complete the tasks, then assigned to the user during the operating session of the vehicle.

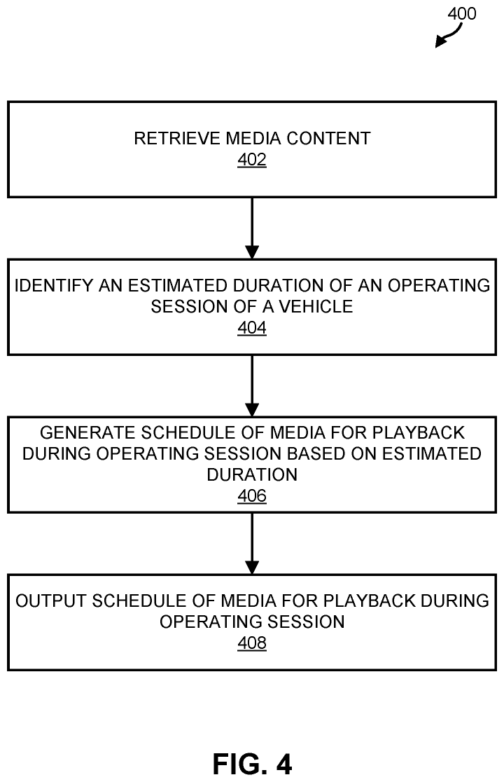

FIG. 4 is a flowchart illustrating an example process 400 to output media content based on time. The process 400 is performed by one or more computing devices, such as a vehicle infotainment system, a user's mobile device, or one or more remote devices (e.g., a server) communicating with a vehicle infotainment system or mobile device over a network. Other embodiments of the process 400 include additional, fewer, or different steps, and the steps can be performed in different orders.

As shown in FIG. 4, the computing device retrieves media content (block 402). Media content can include any of a variety of content types, such as music, podcasts, audio books, videos, or games. Each content item has an associated runtime, representing an amount of time the content item will play or take to complete from its start until its end. In some cases, the content retrieved at block 402 includes content that has been explicitly selected by a user. For example, entertainment media can include a series of songs downloaded by the user or a movie queued by the user on the computing device or another device communicatively coupled to the computing device. In other cases, the computing device selects content based on a user profile of the user. For example, if a user has listened to the first three episodes of a podcast series, the computing device may select the fourth episode. As another example, the computing device selects music or videos that are likely to be of interest to the user, based on other music or videos the user has consumed. In still other cases, the media content retrieved at block 402 includes content selected based on a context of the vehicle or the operating session, with or without reference to the user's profile. For example, content can be selected based on time of day, day of the week, current vehicle location, specified destination, weather, traffic conditions, nearby holidays, or whether the vehicle is manually or autonomously operated.

At block 404, the computing device identifies an estimated duration of an operating session of a vehicle. An operating session is a discrete period of time in which an activity associated with vehicle operation is performed. For example, an operating session represents an instance of operating the vehicle to travel from a specified first location to a specified second location, whether the user is responsible for operating the vehicle (e.g., if the vehicle is a car and the user is the driver of the car) or a passive passenger in the vehicle (e.g., if the vehicle is an airplane and the user is a passenger on the plane). Another example operating session represents an instance of recharging an operative battery in a vehicle.

If the operating session entails driving the vehicle from a first location to a second location, some implementations of the computing device identify the estimated duration before the drive begins by accessing a global positioning sensor in the vehicle or user device to determine the first (starting) location of the vehicle. The computing device determines an estimated time to travel to the second location from the first location, accounting for factors such as current traffic congestion, total miles to travel, time of the day, or weather conditions. The estimated time can be determined using, for example, a map application executed by the computing device.

If the operating session entails recharging the battery of the vehicle, some implementations of the computing device identify the estimated duration by accessing a battery sensor that is configured to output a state of charge of the battery. From the state of charge, the computing device predicts an amount of time it will take to recharge the battery to a full charge given an expected power output of a charger. The expected power output of the charger can be determined, for example, by identifying the power output of a charger most frequently used by the user, identifying the power output of a charger that is closest to the vehicle's current location, or by calculating the power output from an initial portion of the charging session.

At block 406, the computing device generates a schedule of media for playback during the operating session, based on the estimated duration of the operating session. In particular, the computing device selects one or more content items that together have a runtime that corresponds to the estimated duration of the operating session. In some embodiments, the runtime of media content can be determined to correspond to the estimated duration if the runtime is less than the estimated duration, and a difference between the runtime and the estimated duration is less than a threshold. For example, if the estimated operation duration is 15 minutes, the scheduled entertainment media can include a single audio article that has a runtime of 14 minutes because the runtime is less than the 15-minute operating duration, and a difference between 15 minutes and 14 minutes is less than an example threshold of 1.5 minutes. In other embodiments, the runtime of media content corresponds to the estimated operating duration if a difference between the runtime and the estimated operating duration is less than a threshold, regardless of whether the runtime is greater than or less than the operating duration. For example, if the estimated operation duration is 1 hour, the computing device may schedule two video articles, each with a 31-minute runtime, for output during the operating session.

When generating the schedule of media, some embodiments of the computing device can change a playback speed of some types of content such that the actual playback duration of the content item corresponds to the estimated duration of the operating session. Audiobooks or podcasts, for example, can be played at marginally faster or slower rates if the true runtime would not fit within the duration of the operating session but such a change of playback rate would enable the audiobook, chapter of the audiobook, or podcast to fit within the duration. The computing device may apply predefined or user-selected boundaries to the range of playback rates. For example, the computing device may only adjust the playback rate to a rate within the range of 0.9×-1.3× the true playback rate of a content item. Alternatively, the computing device may apply selected modifications to content items to fit the items within the estimated duration. For example, the computing device may shorten a movie by removing end credits if removing the credits would give the movie a runtime that approximately corresponds to the estimated operating duration. As another example, the computing device selects a number of advertisements to play during a podcast episode so that the total runtime of the podcast with the selected advertisements approximately corresponds to the estimated operating duration.

The media content items included in the schedule can be selected, in some cases, from content items selected by the user. For example, if the user has indicated that they have interest in an audio article, that article may be included in the schedule of media to be played back during the estimated operation duration. The selected media by the user can include the most recent type of media played by the user in the vehicle or on an associated device. In other embodiments, the selected media can be media recommended to the user based on media previously selected by the user.

In some embodiments, the media content items selected for the schedule may be modified based on environmental conditions of the vehicle. For example, if the user is driving the vehicle, the user may be unable to view video content. In this example, rather than displaying video, a series of audio articles may be selected that correspond to the estimated operation duration. On the other hand, if the user is waiting for the vehicle to recharge, the user may be interested in a more immersive content item that includes both visual and audio content. In this case, the computing device may select a video or video game to include in the schedule.

In some embodiments, the media content items in the schedule can be assigned a defined order. For instance, multiple audio articles with a combined run-time that matches an estimated operation duration can be arranged in an order that increases user experience. The media can be arranged in a specific order, such as a chronological order, an order specified by a curator of the content, etc. For example, sequential episodes of a podcast or television show can be added to the schedule according to the order of the episodes. The computing device can instead define the order to modify an emotional state of the user. For example, the computing device selects an order for content items (e.g., songs) that will progressively energize the user, relax the user, or otherwise change the user's emotional state, based on the user's current emotional state and/or context of the vehicle.

At block 408, the computing device outputs the schedule of media for playback during the operating session. The media may output via various output components in the vehicle (such as a speaker, a display, the infotainment system, etc.).

The actual duration of the operating session may deviate from the estimated duration. A drive from one location to another, for example, can take more or less time than predicted at the beginning of the drive, due to factors such as the actual speed driven by the user, changes in traffic congestion, weather changes, or other unpredictable or variable factors. Users may also change the destination while en route, or add or remove stops between the starting and ending locations of the drive. If the estimated duration of the operating session changes during the course of the operating duration, the computing device can modify the schedule of content items such that the schedule corresponds to the updated estimated duration. For example, content items can be added to or removed from the schedule, or the rate of playback of content items can be adjusted to fit the updated estimate of the duration.

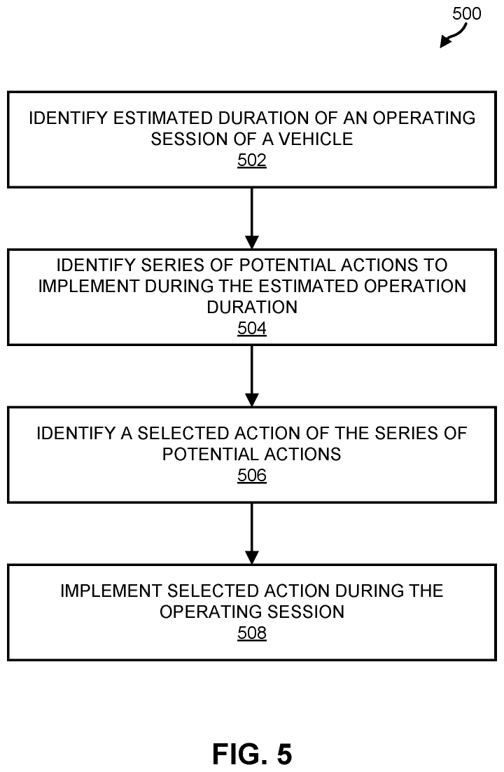

FIG. 5 is a flowchart illustrating an example process 500 to implement a selected action that corresponds to an estimated operation duration of a vehicle. Like the process 400 described with respect to FIG. 4, the process 500 is performed by one or more computing devices, such as a vehicle infotainment system, a user's mobile device, or one or more remote devices (e.g., a server) communicating with a vehicle infotainment system or mobile device over a network. Other embodiments of the process 500 include additional, fewer, or different steps, and the steps can be performed in different orders.

As shown in FIG. 5, the computing device identifies an estimated duration of an operating session of a vehicle at block 502. The estimated operation duration of a vehicle can include, for example, an estimated time to reach a destination, or an estimated time to recharge the battery of an electric vehicle. In some instances, the estimated operation duration can be predictive, i.e. the estimated operation duration can be estimated based on historical traffic patterns. In these instances, the system can provide times to the user of when to leave to the destination based on various criteria (e.g., when there is less traffic, when the user has time in their schedule).

At block 504, the computing device identifies a series of potential actions to implement during the operating session. A potential action can include an action that is capable of being performed during the estimated operation duration—that is, an action that, potentially together with one or more other actions, can be completed in an amount of time that is approximately equivalent to the estimated duration of the operating session of the vehicle. Example potential actions can include playback of audio/video content, playing of a game, making a phone call, or completing a work or crowdsourced project task. The system can identify each potential action that can be performed during the operating session based on its estimated duration and present the potential actions to the user. Some of the potential actions may have a predefined time associated with them. For example, an item of audio or video content typically has a predefined runtime from the start of the content item to its finish. For other potential actions, the computing device derives an estimated time to perform the action from previous activities by the user or other users. If the potential action is a work task the user often performs for his or her vocation, for example, the computing device estimates the amount of time needed to perform the work task as an average amount of time the user typically spends on the task. As another example, if the potential task is playing a level of a video game, the computing device may estimate the amount of time needed to play the level based on an average amount of time in which other players have completed the level.

At block 506, the computing device identifies a selected action of the series of potential actions (block 506). The selected action may be provided via an indication (e.g., voice response, selection on a display) from the user. For example, upon an audio indication that a game can be played during the estimated operation duration, the user can provide a verbal confirmation to play the game, and the system can identify the selected action based on the confirmation.

At block 508, the computing device implements the selected action during the operating session. Implementing an action can include utilizing various components disposed in the vehicle to perform the selected action. For example, a heads-up display can play a selected video. As another example, the system may instruct a mobile phone to initiate a phone call with an identified individual. In some embodiments, the selected action may be scheduled to be performed when the vehicle is in operation. For example, if a user needs to place a call that will take approximately the same amount of time as an upcoming travel session, the computing device can schedule the call to occur during the travel session.

The processes described with respect to FIGS. 4 and 5 can be combined or steps interchanged, in some embodiments. For example, if an action selected by a user will take less time than the estimated duration of the operating session, the computing device can schedule media content items for playback after the user completes the action to fill the remaining time for the operating session.

### Example Processing System

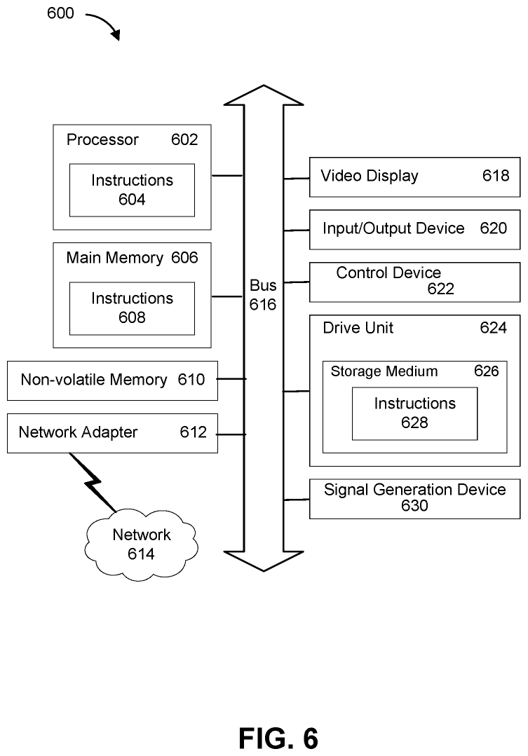

FIG. 6 is a block diagram illustrating an example of a processing system 600 in which at least some operations described herein can be implemented. For example, the automotive experience system, a user device, or the computing device, may be implemented as the example processing system 600. The processing system 600 may include one or more central processing units (“processors”) 602, main memory 606, non-volatile memory 610, network adapter 612 (e.g., network interfaces), video display 618, input/output devices 620, control device 622 (e.g., keyboard and pointing devices), drive unit 624 including a storage medium 626, and signal generation device 630 that are communicatively connected to a bus 616. The bus 616 is illustrated as an abstraction that represents any one or more separate physical buses, point to point connections, or both connected by appropriate bridges, adapters, or controllers. The bus 616, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, also called “Firewire.”

In various embodiments, the processing system 600 operates as part of a user device, although the processing system 600 may also be connected (e.g., wired or wirelessly) to the user device. In a networked deployment, the processing system 600 may operate in the capacity of a server or a client machine in a client-server network environment, or as a peer machine in a peer-to-peer (or distributed) network environment.

The processing system 600 may be a server computer, a client computer, a personal computer, a tablet, a laptop computer, a personal digital assistant (PDA), a cellular phone, a processor, a web appliance, a network router, switch or bridge, a console, a hand-held console, a gaming device, a music player, network-connected (“smart”) televisions, television-connected devices, or any portable device or machine capable of executing a set of instructions (sequential or otherwise) that specify actions to be taken by the processing system 600.

While the main memory 606, non-volatile memory 610, and storage medium 626 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 628. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 604, 608, 628) set at various times in various memory and storage devices in a computer, and that, when read and executed by one or more processing units or processors 602, cause the processing system 600 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. For example, the technology described herein could be implemented using virtual machines or cloud computing services.

Further examples of machine-readable storage media, machine-readable media, or computer-readable (storage) media include, but are not limited to, recordable type media such as volatile and non-volatile memory devices 610, floppy and other removable disks, hard disk drives, optical disks (e.g., Compact Disk Read-Only Memory (CD ROMS), Digital Versatile Disks (DVDs)), and transmission type media, such as digital and analog communication links.

The network adapter 612 enables the processing system 600 to mediate data in a network 614 with an entity that is external to the processing system 600 through any known and/or convenient communications protocol supported by the processing system 600 and the external entity. The network adapter 612 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 612 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

From the foregoing, it will be appreciated that specific embodiments of the invention have been described herein for purposes of illustration, but that various modifications may be made without deviating from the scope of the invention.

I/We claim:

1. A method comprising:
receiving by a computing device, an indication to begin an operating session of a vehicle;
determining, by the computing device, an estimated duration of the operating session using at least one of:
a global positioning sensor in the computing device, configured to output a current geographic location of the vehicle relative to a destination geographic location specified in the indication, wherein determining the estimated duration of the operating session comprises estimating an amount of time for the vehicle to travel from the current geographic location to the destination geographic location; or
a battery sensor coupled to an operative battery in the vehicle, configured to output a current state of charge of the operative battery, wherein determining the estimated duration of the operating session comprises estimating an amount of time for the operative battery to be recharged given the current state of charge;
generating a schedule of media including one or more media content items that together have a collective runtime corresponding to the estimated duration of the operating session; and
during the operating session, outputting the schedule of media for playback by an output device in the vehicle.

2. The method of claim 1, wherein generating the schedule of media comprises selecting a media content item based on a user profile of a user in the vehicle.

3. The method of claim 1, wherein generating the schedule of media comprises selecting a media content item based on a context of the vehicle, the context including at least one of a time of day, day of the week, current vehicle location, specified destination, weather, traffic conditions, or nearby holiday.

4. The method of claim 1, further comprising:
detecting an increase to the estimated duration of the operating session during the operating session; and
adding an additional content item to the schedule of media that has a runtime corresponding to the increase to the estimated duration.

5. The method of claim 1, further comprising:
detecting a decrease to the estimated duration of the operating session during the operating session; and
removing one or more content items from the schedule of media based on the decrease to the estimated duration.

6. A vehicle infotainment system, comprising:
a processor; and
a non-transitory computer readable storage medium storing executable computer program instructions, the computer program instructions when executed by the processor causing the processor to:
determine an estimated duration of an operating session of a vehicle;
generate a schedule of media including one or more media content items that together have a collective runtime corresponding to the estimated duration of the operating session; and
during the operating session, output the schedule of media for playback.

7. The system of claim 6, wherein the operating session is a session of travel from a first location to a second location, and wherein determining the estimated duration of the operating session comprises:
retrieving an identification of the first location by accessing a global positioning sensor associated with the vehicle; and
determining the estimated duration of the operating session by estimating an amount of time for the vehicle to travel from the first location to the second location.

8. The system of claim 7, wherein generating the schedule of media comprises selecting audio-only media content items for the session of travel.

9. The system of claim 6, wherein the operating session is a session to recharge an operative battery of the vehicle, and wherein determining the estimated duration of the operating session comprises:
retrieving a current state of charge of the operative battery by accessing a battery sensor coupled to the operative battery; and
determining the estimated duration of the operating session by estimating an amount of time for the operative battery to be recharged given the current state of charge.

10. The system of claim 9, wherein generating the schedule of media comprises selecting video or audio content items for the session to recharge the operative battery.

11. The system of claim 6, wherein generating the schedule of media comprises selecting a media content item based on a user profile of a user in the vehicle.

12. The system of claim 6, wherein generating the schedule of media comprises selecting a media content item based on a context of the vehicle, the context including at least one of a time of day, day of the week, current vehicle location, specified destination, weather, traffic conditions, or nearby holiday.

13. The system of claim 6, further comprising:
detecting an increase to the estimated duration of the operating session during the operating session; and
adding an additional content item to the schedule of media that has a runtime corresponding to the increase to the estimated duration.

14. The system of claim 6, further comprising:
detecting a decrease to the estimated duration of the operating session during the operating session; and
removing one or more content items from the schedule of media based on the decrease to the estimated duration.

15. A non-transitory computer readable storage medium storing executable computer program instructions, the computer program instructions when executed by a processor causing the processor to:
determine an estimated duration of an operating session of a vehicle by accessing a sensor configured to measure a state of the vehicle before the operating session;
identifying an action to perform during the operating session, the action identified based on an estimated time to complete the action corresponding to the estimated duration of the operating session; and
implement the action in the vehicle during the operating session.

16. The non-transitory computer readable storage medium of claim 15, wherein the operating session is a session of travel from a first location to a second location, and wherein determining the estimated duration of the operating session comprises:
retrieving an identification of the first location by accessing a global positioning sensor associated with the vehicle; and
determining the estimated duration of the operating session by estimating an amount of time for the vehicle to travel from the first location to the second location.

17. The non-transitory computer readable storage medium of claim 15, wherein the operating session is a session to recharge an operative battery of the vehicle, and wherein determining the estimated duration of the operating session comprises:
retrieving a current state of charge of the operative battery by accessing a battery sensor coupled to the operative battery; and
determining the estimated duration of the operating session by estimating an amount of time for the operative battery to be recharged given the current state of charge.

18. The non-transitory computer readable storage medium of claim 15, wherein the computer program instructions further cause the processor to:
generate a schedule of one or more media content items that each have a runtime, wherein the estimated time to complete the action and the runtimes of each of the one or more media content items together correspond to the estimated duration of the operating session.

19. The non-transitory computer readable storage medium of claim 15, wherein identifying the action to perform comprises identifying the estimated time to complete the action based on an average amount of time to complete the action by a user of the vehicle or other users.

20. The non-transitory computer readable storage medium of claim 15, wherein the action comprises playing audio or video content, playing a game, making a phone call, or completing a work or crowdsourced project task.
